(19) United States
(12) Patent Application Publication
(10) Pub. No.: US 2009/0237393 A1
(43) Pub. Date: Sep. 24, 2009

(54) ELECTROPHORETIC DISPLAY DEVICE DRIVING METHOD, ELECTROPHORETIC DISPLAY DEVICE, AND ELECTRONIC APPARATUS

(75) Inventor: Hidetoshi Saito, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 12/370,712

(22) Filed: Feb. 13, 2009

(30) Foreign Application Priority Data
Mar. 24, 2008 (JP) 2008-075438

(51) Int. Cl. G09G 5/00; G09G 3/34

(52) U.S. Cl. 345/214; 345/107

(57) ABSTRACT

A method for driving an electrophoretic display device that is provided with a display unit having a pixel is provided. The pixel of the electrophoretic display device has a pixel electrode, a common electrode, an electrophoretic element containing a plurality of electrophoretic particles, the electrophoretic element being located between the pixel electrode and the common electrode, a pixel-switching element, and a latch circuit that is connected between the pixel electrode and the pixel-switching element. The method for driving an electrophoretic display device includes: during an image display time period, causing the display unit to display an image; during an image holding time period, holding the displayed image; and during a refresh time period, causing the display unit to display the image again. In the image holding time period of the driving method, the power voltage of the latch circuit is set at the minimum voltage of a power system provided in the electrophoretic display device.

### BACKGROUND

1. Technical Field

The present invention relates to a method for driving an electrophoretic display device, an electrophoretic display device, and an electronic apparatus that is provided with an electrophoretic display device.

2. Related Art

As an example of various kinds of active matrix electrophoretic display devices, a display device that has a switching transistor and a memory circuit such as a static random access memory (SRAM) in each of a plurality of pixels thereof is known in the technical field to which the present invention pertains. An example of such an electrophoretic display device of the related art is described in JP-A-2003-84314. The related-art display device described in JP-A-2003-84314 is manufactured by bonding a first substrate over the surface of which pixel electrodes and other components, lines, and the like have been formed in a separate process in advance to a second substrate having an electrophoretic element that is made up of a plurality of microcapsules arrayed adjacent to one another in such a manner that the electrophoretic element is sandwiched between the first substrate and the second substrate.

The related-art display device described in JP-A-2003-84314 displays a black/white image as follows. Either one of two values, that is, black or white, is memorized as an electric potential (low/high level) in an SRAM (i.e., latch circuit) that is provided in a pixel. The output electric potential of the latch circuit is applied to the pixel electrode. By this means, a black image or a white image is displayed. Generally speaking, an electrophoretic display device can hold, that is, keep or retain, a display image even when the power of a latch circuit is turned OFF after an image was displayed once. Though an electrophoretic display device can hold a display image even when the power of a latch circuit is turned OFF, the contrast level thereof decreases as time elapses. For this reason, it may be necessary to display the contrast-decreased image again so as to recover an original contrast level and/or a previous contrast level. Such re-display of a contrast-decreased image for contrast recovery is called as “refreshing operation”. When refreshing operation is executed for contrast recovery, in the related art, it is necessary to supply a power voltage again to the latch circuit that is in a power OFF state so as to switch the latch circuit ON. In addition, it is necessary to write an image signal (i.e., image data) again into the latch circuit. Since it is necessary to operate a driving circuit again for turning the power of the latch circuit ON, a relatively large amount of power is consumed for refreshing operation, which is one of non-limiting technical disadvantages of the related art. Although it is possible to make it unnecessary to operate the driving circuit at the time of the refreshing operation if the latch circuit is continued to be powered ON after the display of an image, such continued power supply to the latch circuit results in extra power consumption.

### SUMMARY

An advantage of some aspects of the invention is to provide an electrophoretic display device that is capable of refreshing a display image with small power consumption and a method for driving such an electrophoretic display device.

In order to address the above-identified problems without any limitation thereto, the invention provides, as a first aspect thereof, a method for driving an electrophoretic display device that is provided with a display unit having a plurality of pixels in each of which an electrophoretic element containing a plurality of electrophoretic particles is sandwiched between a pair of substrates that face each other, each pixel of the electrophoretic display device having a pixel electrode, a pixel-switching element, and a latch circuit connected between the pixel electrode and the pixel-switching element, the driving method including: an image display step of causing the display unit to display an image; an image holding step of holding the displayed image; and a refresh step of causing the display unit to display the image again; wherein, in the image holding step, the power voltage of the latch circuit is set at the minimum voltage of a power system provided in the electrophoretic display device.

In the method for driving an electrophoretic display device according to the first aspect of the invention described above, since the latch circuit is kept ON in the image holding step, it is not necessary to perform the rewriting of an image signal in the refresh step. Therefore, it is not necessary to operate the driving circuit in this step. In addition, since the power voltage of the latch circuit is set at the minimum voltage of a power system provided in the electrophoretic display device in the image holding step, it is possible to minimize the power consumption of the latch circuit in this step. Thus, the method for driving an electrophoretic display device according to the first aspect of the invention described above makes it possible to refresh a display image with small power consumption.

In the method for driving an electrophoretic display device according to the first aspect of the invention described above, it is preferable that the above-mentioned minimum voltage should be the voltage of a battery provided in the power system. With such a preferred driving method, it is possible to hold, that is, keep or maintain, the electric potential of the latch circuit with a simple power system because the battery voltage is directly used for the purpose of maintaining the electric potential of the latch circuit. Note that the battery voltage, that is, cell voltage, is usually the minimum voltage of an apparatus.

In the method for driving an electrophoretic display device according to the first aspect of the invention described above, it is preferable that, in the refresh step, the power voltage of the latch circuit should be raised from the above-mentioned minimum voltage to a voltage that is high enough to drive the electrophoretic element. With such a preferred driving method, it is possible to execute refreshing operation in a reliable manner, thereby achieving a speedy contrast recovery.

In order to address the above-identified problems without any limitation thereto, the invention provides, as a second aspect thereof, an electrophoretic display device that includes: a pair of substrates that face each other; and a display unit that has a plurality of pixels in each of which an electrophoretic element containing a plurality of electrophoretic particles is sandwiched between the pair of substrates, each pixel of the electrophoretic display device having a pixel electrode, a pixel-switching element, and a latch circuit connected between the pixel electrode and the pixel-switching element, the electrophoretic display device being operated in a sequence of time periods including an image display time period throughout which or in which the display unit is caused to display an image, an image holding time period throughout which or in which the displayed image is held, and a refresh time period throughout which or in which the display unit is caused to display the image again, wherein, throughout the image holding time period or in the image holding time period, the power voltage of the latch circuit is set at the minimum voltage of a power system provided in the electrophoretic display device.

In the configuration of an electrophoretic display device according to the second aspect of the invention described above, since the latch circuit is kept ON throughout the image holding time period, it is not necessary to perform the rewriting of an image signal in the refresh time period. Therefore, it is not necessary to operate the driving circuit in this time period. In addition, since the power voltage of the latch circuit is set at the minimum voltage of a power system provided in the electrophoretic display device throughout the image holding time period, it is possible to minimize the power consumption of the latch circuit in this time period. Thus, the electrophoretic display device according to the second aspect of the invention described above makes it possible to refresh a display image with small power consumption.

In the configuration of the electrophoretic display device according to the second aspect of the invention described above, it is preferable that the above-mentioned minimum voltage should be the voltage of a battery provided in the power system. With such a preferred configuration, it is possible to perform the operation of the image holding time period with the use of a simple circuit because the battery voltage is directly used for the purpose of maintaining the electric potential of the latch circuit.

It is preferable that the electrophoretic display device according to the second aspect of the invention described above should further include a voltage selection circuit that supplies a plurality of power voltages to the latch circuit while performing a switchover among the plurality of power voltages, the voltage selection circuit being capable of outputting selected one through an output terminal among a first high level electric potential, which is the maximum electric potential, a second high level electric potential, and a third high level electric potential, which is the minimum electric potential, wherein a first switching circuit, which supplies the first high level electric potential to the output terminal, has a high withstand voltage transistor and a first level shifter, the first level shifter being electrically connected to the gate terminal of the high withstand voltage transistor; a second switching circuit, which supplies the second high level electric potential to the output terminal, has a first low withstand voltage transistor, a second level shifter, and a first diode, the second level shifter being electrically connected to the gate terminal of the first low withstand voltage transistor, the first diode being interposed between the first low withstand voltage transistor and the output terminal; and a third switching circuit, which supplies the third high level electric potential to the output terminal, has a second low withstand voltage transistor and a second diode, which is interposed between the second low withstand voltage transistor and the output terminal. The electrophoretic display device having a preferred configuration described above is provided with a voltage selection circuit that is capable of supplying the third high level electric potential, which is used for keeping the electric potential of the latch circuit in the image holding time period. The voltage selection circuit having the configuration described above offers advantages of a smaller circuit area size and a smaller leakage current amount because of the reduced number of high withstand voltage transistors.

In order to address the above-identified problems without any limitation thereto, the invention provides, as a third aspect thereof, an electronic apparatus that is provided with the electrophoretic display device according to the second aspect of the invention described above. Being provided with such an electrophoretic display device, the electronic apparatus according to this aspect of the invention is capable of continuously displaying an image with excellent contrast for a long time period with small power consumption.

### BRIEF DESCRIPTION OF THE DRAWINGS

The invention will be described with reference to the accompanying drawings, wherein like numbers reference like elements.

FIG. 1 is a schematic diagram that illustrates an example of the configuration of an electrophoretic display device according to a first embodiment of the invention.

FIG. 2 is a circuit diagram that schematically illustrates an example of the configuration of one of pixels of an electrophoretic display device according to the first embodiment of the invention.

FIG. 3 is a sectional view that schematically illustrates an example of the partial configuration of the image display unit of an electrophoretic display device according to the first embodiment of the invention.

FIG. 4 is a diagram that schematically illustrates, in a sectional view, an example of the configuration of a microcapsule.

FIGS. 5A and 5B is a set of diagrams that schematically illustrates an example of the operation of electrophoretic particles provided in an electrophoretic display device according to an exemplary embodiment of the invention; or, more specifically, FIG. 5A shows a white display migration state of electrophoretic particles, whereas FIG. 5B shows a black display migration state of electrophoretic particles.

FIG. 6 is a block diagram that schematically illustrates an example of the configuration of a controlling unit that is provided in an electrophoretic display device according to the first embodiment of the invention.

FIGS. 7A and 7B is a set of circuit diagrams that schematically illustrates an example of the configuration of a voltage selection circuit and a level shifter; or, more specifically, FIG. 7A is a diagram that schematically illustrates an example of the circuit configuration of a voltage selection circuit according to an exemplary embodiment of the invention, whereas FIG. 7B is a diagram that schematically illustrates an example of the circuit configuration of a level shifter, which is a component of the voltage selection circuit.

FIG. 8 is a flowchart that schematically illustrates an example of the operation flow of a method for driving an electrophoretic display device according to the first embodiment of the invention.

FIG. 9 is a timing chart that schematically illustrates an example of the timing operation of a method for driving an electrophoretic display device according to the first embodiment of the invention.

FIG. 10 is a diagram that schematically illustrates two arbitrary selected pixels that are referred to as an example in the explanation of a method for driving an electrophoretic display device according to the first embodiment of the invention.

FIG. 11 is a schematic diagram that illustrates an example of the configuration of an electrophoretic display device according to a second embodiment of the invention.

FIG. 12 is a circuit diagram that schematically illustrates an example of the configuration of one of pixels of an electrophoretic display device according to the second embodiment of the invention.

FIG. 13 is a timing chart that schematically illustrates an example of the timing operation of a method for driving an electrophoretic display device according to the second embodiment of the invention.

FIG. 14 is a diagram that schematically illustrates two arbitrary selected pixels that are referred to as an example in the explanation of a method for driving an electrophoretic display device according to the second embodiment of the invention.

FIG. 15 is a front view that schematically illustrates an example of the configuration of a watch as an example of various kinds of electronic apparatuses to which an electrophoretic display device according to an exemplary embodiment of the invention can be applied.

FIG. 16 is a perspective view that schematically illustrates an example of the configuration of a sheet of electronic paper, which is another example of a variety of electronic apparatuses.

FIG. 17 is a perspective view that schematically illustrates an example of the configuration of an electronic notebook, which is still another example of a variety of electronic apparatuses.

### DESCRIPTION OF EXEMPLARY EMBODIMENTS

With reference to the accompanying drawings, an electrophoretic display device according to an exemplary embodiment of the invention that is driven in an active matrix drive scheme is explained below. Needless to say, it should be understood that the specific exemplary embodiments described below are provided merely for the purpose of illustrating some modes of the invention, and therefore, never intended to limit the scope of the invention. Various arbitrary and/or discretionary modifications, alterations, changes, adaptations, improvements, or the like can be made on the explanation given herein without departing from the spirit and scope of the invention. Note that, in each of the accompanying drawings that will be referred to in the following description of exemplary embodiments of the invention, the number, dimension and/or scale of components, units, members, and the like are modified from those that will be adopted in an actual implementation of the invention for the purpose of making them easily recognizable in each illustration.

### First Embodiment

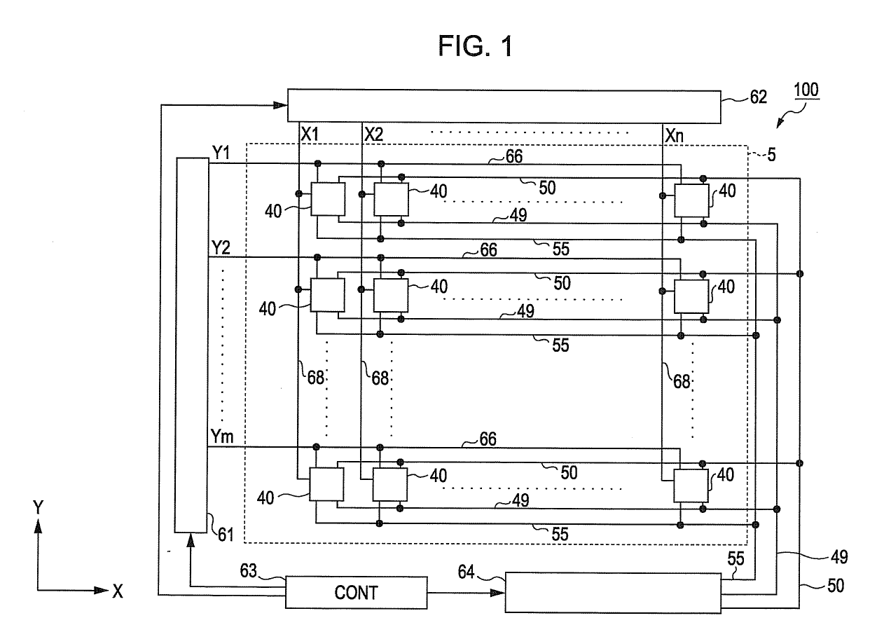

FIG. 1 is a schematic diagram that illustrates an example of the configuration of an electrophoretic display device 100 according to a first embodiment of the invention. The electrophoretic display device 100 is provided with an image display unit 5 in which a plurality of pixels 40 is arrayed in a matrix layout. In the following description of this specification, the image display unit 5 may be referred to as “display area”. A scanning line driving circuit 61, a data line driving circuit 62, a controller (i.e., controlling unit) 63, and a common power supply modulation circuit 64 are provided as peripheral circuits around the display area 5. Each of the scanning line driving circuit 61, the data line driving circuit 62, and the common power supply modulation circuit 64 is electrically connected to the controller 63. The controller 63 is responsible for controlling the entire operation of the electrophoretic display device 100 including the operations of the above-mentioned component circuits, that is, the scanning line driving circuit 61, the data line driving circuit 62, and the common power supply modulation circuit 64 on the basis of image data and an synchronization signal supplied from a higher-level host device. A plurality of scanning lines 66 each of which extends from the scanning line driving circuit 61 and a plurality of data lines 68 each of which extends from the data line driving circuit 62 are formed over the display area 5. Each of the plurality of pixels 40 is provided at a position corresponding to the intersection of the scanning line 66 and the data line 68.

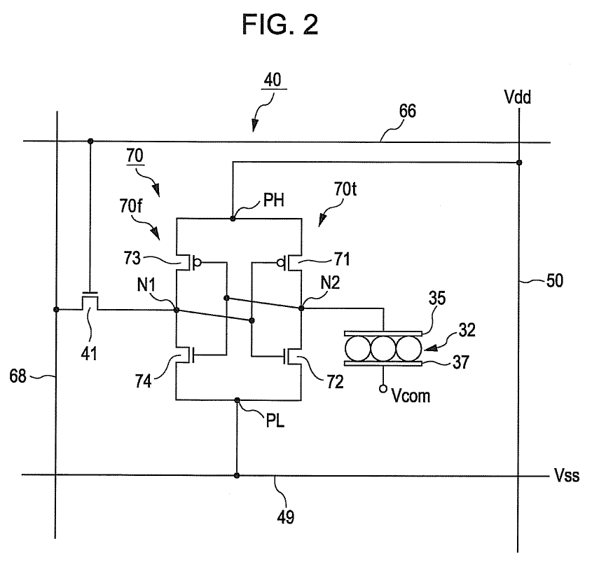

The scanning line driving circuit 61 is electrically connected to all of the plurality of pixels 40 via the m number of scanning lines 66. Note that theses m scanning lines or m scanning rows are denoted as Y1, Y2, . . . , and Ym in the drawing. Specifically, the scanning line driving circuit 61 is electrically connected to each of the first row of pixels 40 through the first scanning line Y1, each of the second row of pixels 40 through the second scanning line Y2, . . . , and each of the m-th row of pixels 40 through the m-th scanning line Ym. Under the control of the controller 63, the scanning line driving circuit 61 selects the first scanning line Y1 through the m-th scanning line Ym in a sequential manner. By this means, the scanning line driving circuit 61 supplies a selection signal to each of the pixels 40 aligned in the selected row through the selected scanning line 66. The selection signal defines the ON timing of a driving TFT that is provided in each of the pixels 40 aligned in the selected row. The driving TFT is illustrated in FIG. 2.

The data line driving circuit 62 is also electrically connected to all of the plurality of pixels 40 via the n number of data lines 68. Note that theses n data lines or n data columns are denoted as X1, X2, . . . , and Xn in the drawing. Specifically, the data line driving circuit 62 is electrically connected to each of the first column of pixels 40 through the first data line X1, each of the second column of pixels 40 through the second data line X2, . . . , and each of the n-th column of pixels 40 through the n-th data line Xn. Under the control of the controller 63, the data line driving circuit 62 supplies an image signal that defines 1-bit pixel data corresponding to each of the pixels 40 thereto. In the configuration of the electrophoretic display device 100 according to the present embodiment of the invention, it is assumed that an image signal having a low level (L) is supplied to the pixel 40 for the pixel data “0” whereas an image signal having a high level (H) is supplied to the pixel 40 for the pixel data “1”.

In addition to the m scanning lines 66 and the n data lines 68 mentioned above, a low voltage power supply line 49, a high voltage power supply line 50, and a common electrode line 55 are formed over the display area 5. The low voltage power supply line 49 may be hereafter referred to as “low electric-potential power line”. The high voltage power supply line 50 may be hereafter referred to as “high electric-potential power line”. Each of the low voltage power supply line 49, the high voltage power supply line 50, and the common electrode line 55 extends from the common power supply modulation circuit 64. Having m-number of branched lines, each of the low voltage power supply line 49, the high voltage power supply line 50, and the common electrode line 55 is electrically connected to all of the plurality of pixels 40. Under the control of the controller 63, the common power supply modulation circuit 64 generates various kinds of signals that should be supplied to the above-mentioned lines. In addition, the common power supply modulation circuit 64 switches over the electric conduction of each of the above-mentioned lines between a connected state and a disconnected state. When disconnected, each of the above-mentioned lines is in a high impedance state.

FIG. 2 is a circuit diagram that schematically illustrates an example of the configuration of one of the pixels 40 of the electrophoretic display device 100 according to the first embodiment of the invention. The pixel 40 is made up of a driving TFT (Thin Film Transistor) 41, a latch circuit 70, an electrophoretic element 32, a pixel electrode 35, and a common electrode 37. The driving TFT 41 described in this specification is a non-limiting example of a “pixel-switching element” according to an aspect of the invention. The latch circuit 70 is a kind of memory circuit. The scanning line 66, the data line 68, the low voltage power supply line 49, and the high voltage power supply line 50 are formed so as to surround these pixel components 41, 70, 32, 35, and 37. The pixel 40 has an SRAM (Static Random Access Memory) configuration. The SRAM is a memory scheme that stores an image signal as an electric potential through the functioning of the latch circuit 70.

In the configuration of the electrophoretic display device 100 according to the present embodiment of the invention, the driving TFT 41 functions as a pixel-switching element. The driving TFT 41 is made of an N-MOS (Negative Metal Oxide Semiconductor) transistor. The gate terminal of the driving TFT 41 is electrically connected to the scanning line 66. The source terminal of the driving TFT 41 is electrically connected to the data line 68. The drain terminal of the driving TFT 41 is electrically connected to the data input terminal N1 of the latch circuit 70. The data output terminal N2 of the latch circuit 70 is electrically connected to the pixel electrode 35. The electrophoretic element 32 is sandwiched between the pixel electrode 35 and the common electrode 37. An electric field is generated due to an electric potential difference, that is, a voltage level difference, between a pixel electrode electric potential that is inputted into the pixel electrode 35 from the latch circuit 70 and a common electrode electric potential Vcom that is inputted into the common electrode 37 through the common electrode line 55, which is illustrated in FIG. 1. In the configuration of the pixel 40 according to the present embodiment of the invention, the electrophoretic element 32 is driven as a result of the generation of the electric field so as to display an image.

The latch circuit 70 includes a transfer inverter 70t and a feedback inverter 70f. Each of the transfer inverter 70t and the feedback inverter 70f is electrically connected to the high voltage power supply line 50 via a high voltage power supply terminal PH. The high voltage power supply terminal PH may be hereafter referred to as “high electric-potential power terminal”. A power voltage is supplied from the high voltage power supply line 50 to each of the transfer inverter 70t and the feedback inverter 70f through the high voltage power supply terminal PH. In addition, each of the transfer inverter 70t and the feedback inverter 70f is electrically connected to the low voltage power supply line 49 via a low voltage power supply terminal PL. The low voltage power supply terminal PL may be hereafter referred to as “low electric-potential power terminal”. A power voltage is supplied from the low voltage power supply line 49 to each of the transfer inverter 70t and the feedback inverter 70f through the low voltage power supply terminal PL. Each of the transfer inverter 70t and the feedback inverter 70f is configured as a C-MOS inverter. The pair of inverters 70t and 70f constitutes an electrically looped structure. In such an electrically looped structure, the input terminal of one inverter circuit is electrically connected to the output terminal of the other. In addition thereto, the input terminal of the other inverter circuit is electrically connected to the output terminal of the above-mentioned one.

The transfer inverter 70t includes a P-MOS (Positive Metal Oxide Semiconductor) transistor 71 and an N-MOS transistor 72. The drain terminal of each of the P-MOS transistor 71 and the N-MOS transistor 72 is electrically connected to the data output terminal N2 of the latch circuit 70. The source terminal of the P-MOS transistor 71 is electrically connected to the high voltage power supply terminal PH, whereas the source terminal of the N-MOS transistor 72 is electrically connected to the low voltage power supply terminal PL. The gate terminal of each of the P-MOS transistor 71 and the N-MOS transistor 72 is electrically connected to the data input terminal N1 of the latch circuit 70. It should be noted that the gate terminal of each of the P-MOS transistor 71 and the N-MOS transistor 72 constitutes the input terminal of the transfer inverter 70t. It should be further noted that the data input terminal N1 of the latch circuit 70 constitutes the output terminal of the feedback inverter 70f.

The feedback inverter 70f includes a P-MOS transistor 73 and an N-MOS transistor 74. The drain terminal of each of the P-MOS transistor 73 and the N-MOS transistor 74 is electrically connected to the data input terminal N1 of the latch circuit 70. The gate terminal of each of the P-MOS transistor 73 and the N-MOS transistor 74 is electrically connected to the data output terminal N2 of the latch circuit 70. It should be noted that the gate terminal of each of the P-MOS transistor 73 and the N-MOS transistor 74 constitutes the input terminal of the feedback inverter 70f. It should be further noted that the data output terminal N2 of the latch circuit 70 constitutes the output terminal of the transfer inverter 70t.

In the configuration of the latch circuit 70 described above, when an image signal having a high level (H), which is herein assumed as image data “1”, is memorized therein, a signal having a low level (L) is outputted from the data output terminal N2 thereof. On the other hand, when an image signal having a low level (L), which is herein assumed as image data “0”, is memorized in the latch circuit 70, a signal having a high level (H) is outputted from the data output terminal N2 thereof.

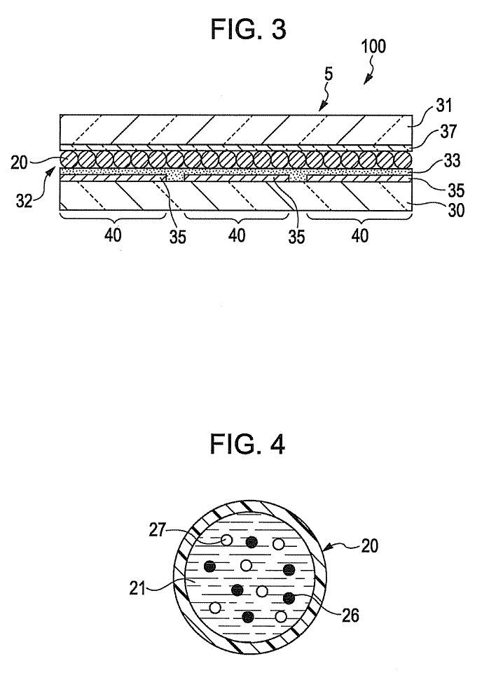

FIG. 3 is a sectional view that schematically illustrates an example of the partial configuration of the image display unit 5 of the electrophoretic display device 100 according to the first embodiment of the invention. In the configuration of the electrophoretic display device 100 according to the present embodiment of the invention, the electrophoretic element 32, which is made up of a plurality of microcapsules 20 arrayed adjacent to one another, is sandwiched between an element substrate 30 and a counter substrate 31. The plurality of pixel electrodes 35 is arrayed adjacent to one another in the image display area 5 on the electrophoretic-element-side (32) surface of the element substrate 30. The electrophoretic element 32 is bonded to the pixel electrodes 35 by means of an adhesive, which forms an adhesive layer 33.

The element substrate 30 is a substrate that is made of glass, plastic, or the like. Since the element substrate 30 is provided at the non-display surface side that is opposite to the image display surface side of the electrophoretic display device 100, the material of the element substrate 30 may not be transparent. The pixel electrode 35 is formed as, for example, a layered electrode that is made up of a nickel plate and a gold plate that are laminated in the order of appearance herein on a copper (Cu) foil. Or, the pixel electrode 35 may be made of aluminum (Al). Alternatively, the pixel electrode 35 may be made of ITO, which is an acronym for indium tin oxide. Though not specifically illustrated in FIG. 3, the aforementioned scanning lines 66, data lines 68, driving TFTs 41, latch circuits 70, and the like, which are illustrated in FIG. 1 and/or FIG. 2, are formed between the pixel electrodes 35 and the element substrate 30.

On the other hand, the counter substrate 31, which is made of glass, plastic, or the like, is configured as a transparent substrate because the counter substrate 31 is provided at the image display surface side of the electrophoretic display device 100. The common electrode 37 is formed on the electrophoretic-element-side (32) surface of the counter substrate 31, which faces toward the plurality of pixel electrodes 35 formed on the above-mentioned electrophoretic-element-side (32) surface of the element substrate 30. The common electrode 37 has a planar shape. The electrophoretic element 32 is provided on the surface of the planar common electrode 37. The common electrode 37 is a transparent electrode that is made of MgAg, ITO, IZO (Indium Zinc Oxide), or the like.

It is a common manufacturing practice to form the electrophoretic element 32 over the above-mentioned surface of the counter substrate 31 in advance as a “prefabricated” electrophoretic sheet, which includes the adhesive layer 33. A protective sheet is provided on the surface of the adhesive layer 33 of the electrophoretic sheet as the protective cover thereof. The electrophoretic sheet is handled with the cover film being attached thereto in a manufacturing process. A laminated structure that is made up of the pixel electrodes 35, various kinds of circuits, elements, lines, and the like is formed in a separate manufacturing process over the element substrate 30. After the protective sheet has been peeled off from the electrophoretic sheet, the uncovered surface of the electrophoretic sheet is pasted on the surface of the laminated structure formed over the element substrate 30. The image display unit 5 is formed in this way. Therefore, the adhesive layer 33 is formed at the pixel-electrode (35) side only.

FIG. 4 is a diagram that schematically illustrates, in a sectional view, an example of the configuration of the microcapsule 20. The microcapsule 20 is configured as a minute capsule that has a diameter of, for example, approximately 30-50 μm. The microcapsule 20 is a globular or spherical capsule inside which a dispersion medium 21, a plurality of white particles 27, and a plurality of black particles 26 are sealed. The plurality of white particles 27 is an example of one component of electrophoretic particles. The plurality of black particles 26 is an example of the other component of electrophoretic particles. As illustrated in the sectional view of FIG. 3, the microcapsules 20 are sandwiched between the pixel electrodes 35 and the common electrode 37. Either one or more microcapsule 20 is provided in each pixel 40 of the image display unit 5 of the electrophoretic display device 100 according to the present embodiment of the invention.

The outer capsule part, that is, wall film, of the microcapsule 20 is made of, for example, an acrylic resin including but not limited to polymethyl methacrylate or polyethyl methacrylate, a urea resin, or a polymeric resin having optical transparency such as gum arabic or the like. The dispersion medium 21 is a liquid, the presence of which enables the white particles 27 and the black particles 26 to be dispersed inside the microcapsule 20. The material of the dispersion medium 21 may be selected from, without any intention to limit thereto: water, alcohol solvent (e.g., methanol, ethanol, isopropanol, butanol, octanol, methyl cellosolve or the like), ester kinds (e.g., ethyl acetate, butyl acetate or the like), ketone kinds (e.g., acetone, methyl ethyl ketone, methyl isobutyl ketone or the like), aliphatic hydrocarbon (e.g., pentane, hexane, octane or the like), alicyclic hydrocarbon (e.g., cyclohexane, methylcyclohexane or the like), aromatic hydrocarbon (e.g., benzene, toluene, benzene kinds having a long-chain alkyl group (e.g., xylene, hexyl benzene, butyl benzene, octyl benzene, nonyl benzene, decyl benzene, undecyl benzene, dodecyl benzene, tridecyl benzene, tetradecyl benzene or the like)), halogenated hydrocarbon (e.g., methylene chloride, chloroform, carbon tetrachloride, 1,2-dichloroethane or the like), carboxylate, or any other kind of oil and fat. The dispersion medium 21 can be formed as either a single chemical element/material/substance or combined chemical elements/materials/substances of those enumerated above without any limitation thereto. In addition, a surfactant (i.e., surface-active agent) may be combined therewith for the production of the dispersion medium 21.

The white particle 27 is constituted as, for example, a particle (i.e., high polymer or colloid) made of white pigment such as titanium dioxide, hydrozincite, antimony trioxide or the like. In the present embodiment of the invention, the white particle 27 is charged negatively though not limited thereto. On the other hand, the black particle 26 is constituted as, for example, a particle (i.e., high polymer or colloid) made of black pigment such as aniline black, carbon black or the like. In the present embodiment of the invention, the black particle 26 is charged positively though not limited thereto. If necessary, a charge-controlling agent, a dispersing agent, a lubricant, a stabilizing agent, or the like, may be added to these pigments. The charge-controlling agent may be made of particles of, for example, electrolyte, surface-active agent, metallic soap, resin, gum, oil, varnish, or compound, though not limited thereto. The dispersing agent may be a titanium-system coupling agent, an aluminum-system coupling agent, a silane-system coupling agent, though not limited thereto. The pigments used for the black particles 26 and the white particles 27 described above may be replaced by, for example, red, green, and blue one, though not limited thereto. If so modified, the electrophoretic display device 100 can display, for example, red, green, and blue on the display area 5 thereof.

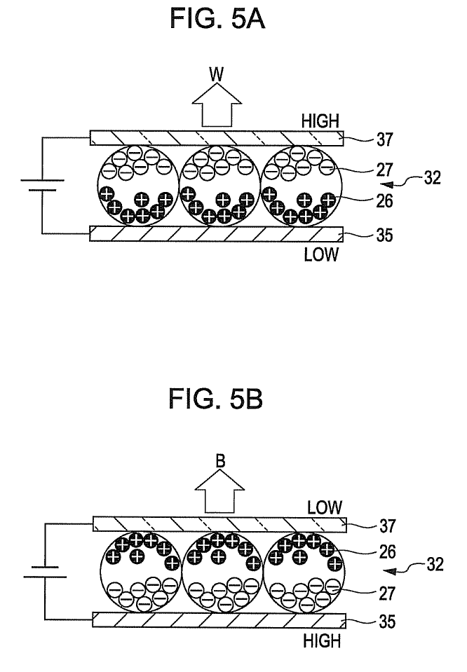

FIGS. 5A and 5B is a set of diagrams that schematically illustrates an example of the operation of the electrophoretic element 32. FIG. 5A shows a white display migration state of electrophoretic particles in which the pixel 40 displays white, whereas FIG. 5B shows a black display migration state of electrophoretic particles in which the pixel 40 displays black. In the operation of the electrophoretic display device 100 according to the present embodiment of the invention, an image signal is inputted to the data input terminal N1 of the latch circuit 70 through the driving TFT 41. Upon the reception of the image signal at the data input terminal N1, the latch circuit 70 stores the image signal as an electric potential. Consequently, the electric potential corresponding to the inputted image signal is outputted from the data output terminal N2 of the latch circuit 70. The outputted electric potential corresponding to the inputted image signal is inputted into the pixel electrode 35. As a result thereof, the pixel 40 is put into either a white display state shown in FIG. 5A or a black display state shown in FIG. 5B on the basis of a difference between the electric potential of the pixel electrode 35 and the electric potential of the common electrode 37.

Specifically, the electric potential of the common electrode 37 is held at a level that is relatively high whereas the electric potential of the pixel electrode 35 is held at a level that is relatively low when the pixel 40 should be put into a white display state, which is illustrated in FIG. 5A. Because of such a voltage level difference, the white particles 27, each of which is negatively charged, are drawn to the common electrode 37, whereas the black particles 26, each of which is positively charged, are drawn to the pixel electrode 35. As a result of the migration, that is, movement, of electrophoretic particles 26 and 27 explained above, a white display is observed when this pixel 40 is viewed from a certain point at the common electrode (37) side, which is herein assumed to be the image display surface side of the electrophoretic display device 100. The display color of white is denoted as W in FIG. 5A. On the other hand, the electric potential of the common electrode 37 is held at a level that is relatively low whereas the electric potential of the pixel electrode 35 is held at a level that is relatively high when the pixel 40 should be put into a black display state, which is illustrated in FIG. 5B. Because of such a voltage level difference, the black particles 26, each of which is positively charged, are drawn to the common electrode 37, whereas the white particles 26, each of which is negatively charged, are drawn to the pixel electrode 35. As a result of the migration of electrophoretic particles 26 and 27 explained above, a black display is observed when this pixel 40 is viewed from a certain point at the common electrode (37) side. The display color of black is denoted as B in FIG. 5B.

### Configuration and Operation of Controlling Unit 63

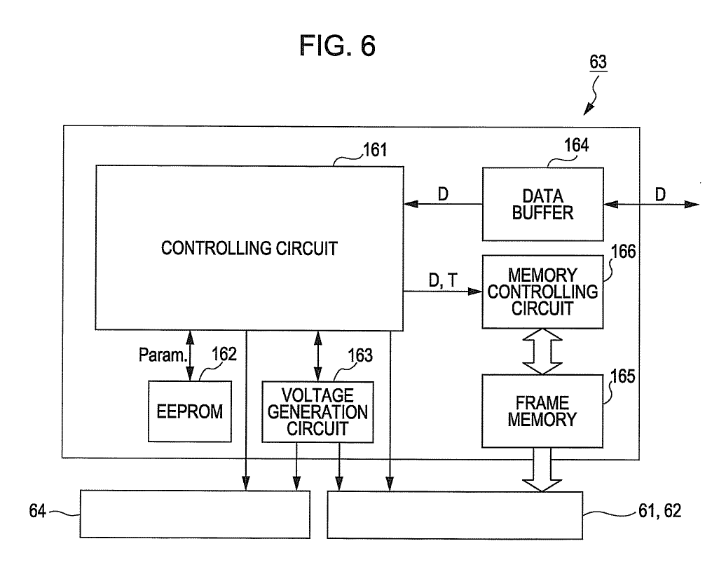

FIG. 6 is a block diagram that schematically illustrates an example of the configuration of the controller 63, which is provided in the electrophoretic display device 100 according to the first embodiment of the invention. The controller 63 is provided with a controlling circuit 161, a memory unit 162, a voltage generation circuit 163, a data buffer 164, a frame memory 165, and a memory controlling circuit 166. The controlling circuit 161 can be embodied as a CPU (Central Processing Unit). The memory unit 162 can be embodied as an EEPROM (Electrically Erasable and Programmable Read-Only Memory).

The controlling circuit 161 generates various kinds of control signals (i.e., timing pulses) such as a clock signal CLK, a horizontal synchronization signal Hsync, a vertical synchronization signal Vsync, and the like. The controlling circuit 161 supplies these control signals to peripheral circuits that are provided around the controlling circuit 161. The EEPROM 162 memorizes set values that are required for controlling the operation of the circuits, which is performed by the controlling circuit 161. Examples of the set values are a mode setting value and a volume value. For example, the EEPROM 162 memorizes a driving sequence set value for each operation mode in the format of an LUT (Look-up Table). In addition thereto, preset image data that is used for displaying the operation state of the electrophoretic display device 100 or the like may have been stored in the EEPROM 162 in advance. The voltage generation circuit 163 is a circuit that supplies a driving voltage to each of the scanning line driving circuit 61, the data line driving circuit 62, and the common power supply modulation circuit 64 mentioned earlier. The data buffer 164 is the interface unit of the controller 63 for performing data interaction with a higher-level device. The data buffer 164 stores image data D that has been inputted from the higher-level device. In addition, the data buffer 164 transfers the image data D to the controlling circuit 161.

The frame memory 165 is a read/write free access memory. The frame memory 165 has a memory space that corresponds to the array of the pixels 40 in the display area 5. The memory controlling circuit 166 expands the image data D, which has been supplied from the controlling circuit 161, so that the expanded data should correspond to the pixel array of the image display unit 5 in accordance with a control signal supplied thereto. Then, the memory controlling circuit 166 writes the expanded data into the frame memory 165. The frame memory 165 sequentially transmits a group of data that is made up of the stored image data D to the data line driving circuit 62 each as an image signal. The data line driving circuit 62 latches the image signals that have been sent from the frame memory 165 one line after another on the basis of the control signal that has been supplied from the controlling circuit 161. Then, in synchronization with the sequential selection of the scanning line 66, which is an operation performed by the scanning line driving circuit 61, the data line driving circuit 62 supplies the latched image signal to the data line 68.

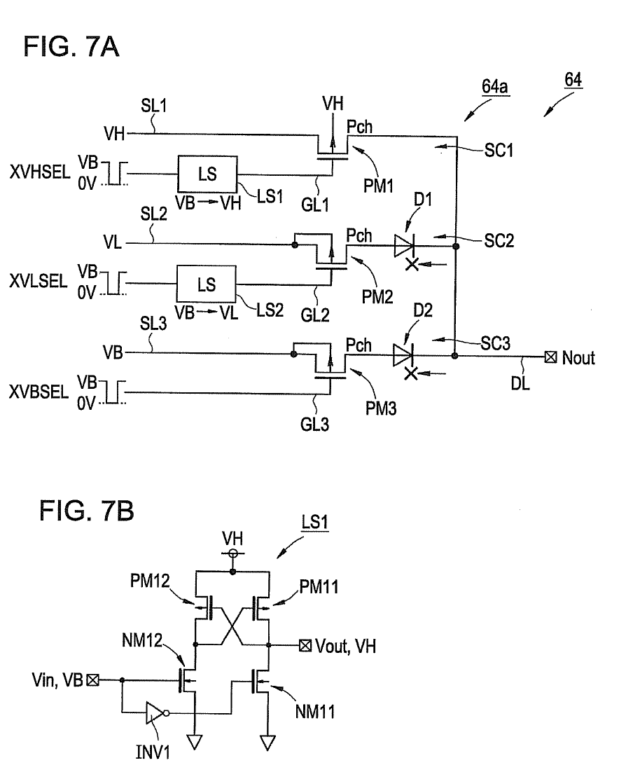

In the configuration of the electrophoretic display device 100 according to the present embodiment of the invention, the common power supply modulation circuit 64 is provided with a voltage selection circuit 64a. The voltage selection circuit 64a supplies a plurality of power electric potentials Vdd to the high voltage power supply line 50 while performing a switchover among the plurality of power electric potentials Vdd. FIGS. 7A and 7B is a set of circuit diagrams that schematically illustrates an example of the configuration of the voltage selection circuit 64a and a level shifter; or, more specifically, FIG. 7A is a diagram that schematically illustrates an example of the circuit configuration of the voltage selection circuit 64a according to an exemplary embodiment of the invention, whereas FIG. 7B is a diagram that schematically illustrates an example of the circuit configuration of a level shifter LS1, which is a component of the voltage selection circuit 64a.

As illustrated in FIG. 7A, the voltage selection circuit 64a is provided with a first switching circuit SC1, a second switching circuit SC2, and a third switching circuit SC3. The first switching circuit SC1 performs an output switchover for a driving high-level electric potential VH. The driving high-level electric potential VH, which may be hereafter referred to as “driving high voltage level”, is inputted through a first input line SL1. The driving high-level electric potential VH or the driving high voltage level VH described in this specification is a non-limiting example of a “first high level electric potential” according to an aspect of the invention. As a non-limiting example thereof, the driving high-level electric potential VH is set at 15V. The second switching circuit SC2 performs an output switchover for a pixel-writing high-level electric potential VL. The pixel-writing high-level electric potential VL, which may be hereafter referred to as “pixel-writing high voltage level”, is inputted through a second input line SL2. The pixel-writing high-level electric potential VL or the pixel-writing high voltage level VL described in this specification is a non-limiting example of a “second high level electric potential” according to an aspect of the invention. As a non-limiting example thereof, the pixel-writing high-level electric potential VL is set at 5V. The third switching circuit SC3 performs an output switchover for a cell electric potential VB. The cell electric potential VB, which may be hereafter referred to as “cell voltage level” or “battery voltage level”, is inputted through a third input line SL3. The cell electric potential VB or the battery voltage level VB described in this specification is a non-limiting example of a “third high level electric potential” according to an aspect of the invention. As a non-limiting example thereof, the cell electric potential VB is set at 2V. The term “battery” is used as a generic concept that encompasses the meaning of “cell” described in this specification without any limitation thereto. Each of the first switching circuit SC1, the second switching circuit SC2, and the third switching circuit SC3 is electrically connected to an output terminal Nout through an output line DL.

The first switching circuit SC1 includes a P-MOS transistor PM1 and a level shifter LS1. The first input line SL1 is electrically connected to the source terminal of the P-MOS transistor PM1, whereas the output line DL is electrically connected to the drain terminal of the P-MOS transistor PM1. The level shifter LS1 is electrically connected to the gate terminal of the P-MOS transistor PM1 through a gate line GL1.

The switching state of the first switching circuit SC1 is controlled on the basis of the input of a switching signal XVHSEL. When a pulse having a ground potential (0V, low level) is inputted into the gate terminal of the P-MOS transistor PM1 as the switching signal XVHSEL, the P-MOS transistor PM1 turns ON. As a result thereof, an electric connection is established between the first input line SL1 and the output line DL. Accordingly, the driving high-level electric potential VH is outputted to the output terminal Nout. The level shifter LS1 generates a high-level electric potential that is used for holding the P-MOS transistor PM1 in an OFF state. Specifically, the level shifter LS1 boosts the cell electric potential VB, which is the power electric potential of the controlling circuit, up to the driving high-level electric potential VH. The raised voltage VH is supplied to the gate line GL1.

The level shifter LS1 has a circuit configuration illustrated in FIG. 7B, which is a non-limiting configuration example. The level shifter LS1 amplifies the amplitude of a signal that is inputted through an input terminal Vin, and then outputs the amplified signal to an output terminal Vout. As shown in the drawing, the level shifter LS1 has two P-MOS transistors PM11 and PM12 and two N-MOS transistors NM11 and NM12. The source terminal of each of these two P-MOS transistors PM11 and PM12 is electrically connected to a high voltage power source (i.e., driving high-level electric potential VH). The source terminal of the N-MOS transistor NM11 is electrically connected to a low voltage power source (i.e., ground potential GND). The source terminal of the N-MOS transistor NM12 is also electrically connected to a ground GND. The drain terminal of the P-MOS transistor PM11 is electrically connected to the drain terminal of the N-MOS transistor NM11, the gate terminal of the P-MOS transistor PM12, and the output terminal Vout. The drain terminal of the P-MOS transistor PM12 is electrically connected to the drain terminal of the N-MOS transistor NM12 and the gate terminal of the P-MOS transistor PM11. An input signal is supplied through the input terminal Vin to the gate terminal of the N-MOS transistor NM12 and the input terminal of an inverter INV1. After the inversion performed at the inverter INV1, the input signal is supplied to the gate terminal of the N-MOS transistor NM11. The level shifter LS1 outputs either a high electric potential (i.e., driving high-level electric potential VH), which is inputted via the P-MOS transistor PM11, as a high level or a low electric potential (i.e., ground potential GND), which is inputted via the N-MOS transistor NM11, as a low level.

The second switching circuit SC2 includes a P-MOS transistor PM2, a level shifter LS2, and a diode D1. The second input line SL2 is electrically connected to the source terminal of the P-MOS transistor PM2, whereas the output line DL is electrically connected to the drain terminal of the P-MOS transistor PM2 with the diode D1 being provided therebetween. The level shifter LS2 is electrically connected to the gate terminal of the P-MOS transistor PM2 through a gate line GL2. The diode D1 is connected thereto in a forward direction from the P-MOS transistor PM2 toward the output line DL.

The switching state of the second switching circuit SC2 is controlled on the basis of the input of a switching signal XVLSEL. When a pulse having a ground potential (0V, low level) is inputted into the gate terminal of the P-MOS transistor PM2 as the switching signal XVLSEL, the P-MOS transistor PM2 turns ON. As a result thereof, an electric connection is established between the second input line SL2 and the output line DL. Accordingly, the pixel-writing high-level electric potential VL is outputted through the diode D1 to the output terminal Nout. The level shifter LS2 generates a high-level electric potential that is used for holding the P-MOS transistor PM2 in an OFF state. Specifically, the level shifter LS2 boosts the cell electric potential VB up to the pixel-writing high-level electric potential VL. The raised voltage VL is supplied to the gate line GL2. The circuit configuration of the level shifter LS2 is substantially the same as that of the level shifter LS1 shown in FIG. 7B except that the pixel-writing high-level electric potential VL is supplied thereto from a high voltage power source. For this reason, it is not necessary to provide a transistor having a high breakdown voltage of 10V or greater as the transistor of the level shifter LS2. A low-resistance transistor having a withstand voltage of 5-6V or so can be adopted as each transistor of the level shifter LS2. In the following description of this specification, the term “low-resistance transistor” is used as a non-limiting example of a “low withstand voltage transistor” according to an aspect of the invention, whereas the term “high-resistance transistor” is used as a non-limiting example of a “high withstand voltage transistor” according to an aspect of the invention.

The third switching circuit SC3 includes a P-MOS transistor PM3 and a diode D2. The third input line SL3 is electrically connected to the source terminal of the P-MOS transistor PM3, whereas the output line DL is electrically connected to the drain terminal of the P-MOS transistor PM3 with the diode D2 being provided therebetween. The gate terminal of the P-MOS transistor PM3 is electrically connected to a gate line GL3. The diode D2 is connected thereto in a forward direction from the P-MOS transistor PM3 toward the output line DL.

The switching state of the third switching circuit SC3 is controlled on the basis of the input of a switching signal XVBSEL. When a pulse having a ground potential (0V, low level) is inputted into the gate terminal of the P-MOS transistor PM3 as the switching signal XVBSEL, the P-MOS transistor PM3 turns ON. As a result thereof, an electric connection is established between the third input line SL3 and the output line DL. Accordingly, the cell electric potential VB is outputted through the diode D2 to the output terminal Nout. No level shifter is provided on the gate line GL3 in the configuration of the third switching circuit SC3.

In the exemplary configuration of the voltage selection circuit 64a described above, the diodes D1 and D2 are provided on the second switching circuit SC2 and the third switching circuit SC3, respectively. By this means, it is possible to decrease the number of high-resistance transistors used. In addition, the configuration of the voltage selection circuit 64a described above achieves a smaller circuit area size while reducing a leakage current. Since it is possible to shut off the driving high-level electric potential VH, which is outputted from the first switching circuit SC1, in the second switching circuit SC2 and the third switching circuit SC3 by means of the diodes D1 and D2, it is not necessary to use any high-resistance transistor for the P-MOS transistors PM2 and PM3. Therefore, it is possible to form each of the P-MOS transistors PM2 and PM3 with the use of a low-resistance transistor that has a withstand voltage that is high enough to withstand against the pixel-writing high-level electric potential VL (e.g., 5V). Thus, it is possible to reduce the size of a transistor.

In addition, since it is not necessary to shut off the driving high-level electric potential VH in the P-MOS transistor PM2, it is possible to use, as the level shifter LS2 that is provided in the second switching circuit SC2, a level shifter that boosts the cell electric potential VB up to the pixel-writing high-level electric potential VL. Therefore, it is possible to provide the level shifter LS2 without using any high-resistance transistor, which results in reduction in the size of the level shifter LS2. Moreover, it is only the cell electric potential VB, which is the minimum voltage of an electrical power system (i.e., power supply system), that is inputted into the P-MOS transistor PM3 of the third switching circuit SC3. Therefore, it is not necessary to provide any level shifter in the third switching circuit SC3.

As explained above, if the circuit configuration of the voltage selection circuit 64a according to the present embodiment of the invention is adopted, it suffices to provide a high-resistance transistor, which has an inevitably large size, in one switching circuit only. In addition to such a non-limiting advantage, it is possible to reduce the area size of a circuit because the number of level shifters is small. Furthermore, since the number of high-resistance transistors is small, it is possible to decrease the amount of a leakage current in the circuit as a whole. That is, since a high-resistance transistor has a relatively large leakage current amount, reduction in the number of high-resistance transistors contributes to reduction in entire leakage current amount. Therefore, it is possible to reduce power consumption.

Although the diodes D1 and D2 are provided in the voltage selection circuit 64a, generally speaking, the size of a diode is smaller than that of a transistor. In addition, the amount of a leakage current of a diode is smaller than that of a transistor. For these reasons, the exemplary configuration of the voltage selection circuit 64a described above features a smaller circuit area size and a smaller leak current amount in comparison with a configuration in which each of the P-MOS transistor PM2 of the second switching circuit SC2 and the P-MOS transistor PM3 of the third switching circuit SC3 is a high-resistance transistor. Furthermore, since the structure of a diode is simple, the number of layout steps for the exemplary configuration of the voltage selection circuit 64a described above is smaller in comparison with the number of layout steps for a configuration in which transistors are provided in place of diodes.

However, there is an adverse possibility that a voltage drop of approximately 0.2-0.6V may occur depending on an input voltage level because a diode has a forward voltage Vf. Taking a voltage-drop possibility into consideration, it is preferable to set the pixel-writing high-level electric potential VL, which is inputted into the second switching circuit SC2, at a higher level in anticipation of such a possible voltage drop. For example, if the output pixel-writing high-level electric potential VL of 5V is required at the output terminal Nout, it is preferable to set the input pixel-writing high-level electric potential VL that is supplied to the voltage selection circuit 64a at 5.5V or so. Notwithstanding the above, however, it is not necessary to perform the input voltage level adjustment described above in anticipation of a possible voltage drop if the writing of an image signal into the latch circuit 70 is not adversely affected at all even when the voltage drop occurs.

Although a voltage drops also at the diode D2 in the third switching circuit SC3, the cell electric potential VB that is outputted from the third switching circuit SC3 is used only for the purpose of holding an electric potential at the latch circuit 70 in an image holding step ST3, which will be explained later. It is reasonably considered that the amount of an electric current that flows through the diode D2 is small because almost no electric current flows in the latch circuit 70 when the latch circuit 70 is in a stable state, that is, a steady state. Therefore, the value of the forward voltage Vf, which depends on a forward electric current, is also small. Thus, it is reasonably expected that a voltage drop that is so large that the memory content of the latch circuit 70 be lost does not occur. In a case where it is difficult to hold the electric potential of the latch circuit 70 though the amount of a voltage drop is not large, however, it is necessary to set the input electric potential at a higher voltage level or take other alternative countermeasures in compensation for the amount of a possible voltage drop as done for the second switching circuit SC2.

### Method for Driving Electrophoretic Display Device

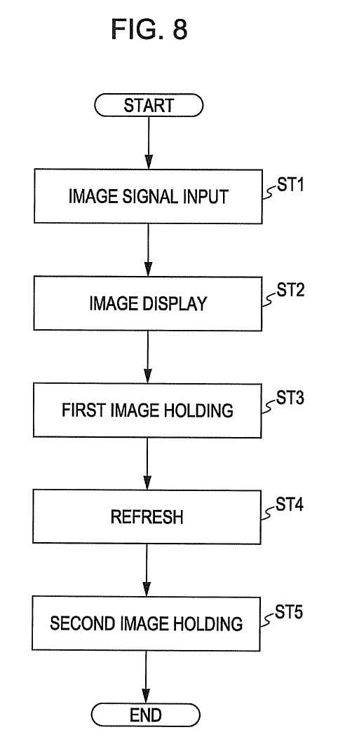

Next, a method for driving the electrophoretic display device 100 having the configuration described above is explained below. FIG. 8 is a flowchart that schematically illustrates an example of the operation flow of a method for driving the electrophoretic display device 100 according to the first embodiment of the invention. As illustrated in FIG. 8, a method for driving the electrophoretic display device 100 according to the present embodiment of the invention includes an image signal input step ST1, an image display step ST2, a first image holding step ST3, a refresh step ST4, and a second image holding step ST5. An image signal is inputted into the latch circuit 70 of the pixel 40 in the image signal input step ST1. An image is displayed on the image display unit 5 on the basis of the written image signal in the image display step ST2. The display image is held in the first image holding step ST3. The “holding” of a display image encompasses the meaning of the keeping or retaining thereof without any limitation thereto. The contrast of the display image is restored in the refresh step ST4. The term “contrast restoration” encompasses the meaning of contrast recovery, that is, the returning of a contrast level to its original and/or previous level without any limitation thereto. The display image is held in the second image holding step ST5. The image signal input step ST1 corresponds to an image signal input time period. The image display step ST2 corresponds to an image display time period. The first image holding step ST3 corresponds to an image holding time period. The refresh step ST4 corresponds to a refresh time period. Finally, the second image holding step ST5 corresponds to another image holding time period.

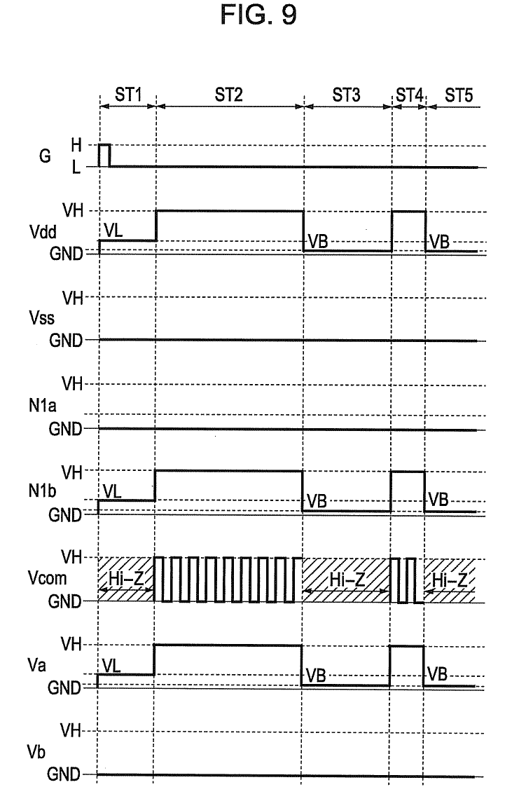

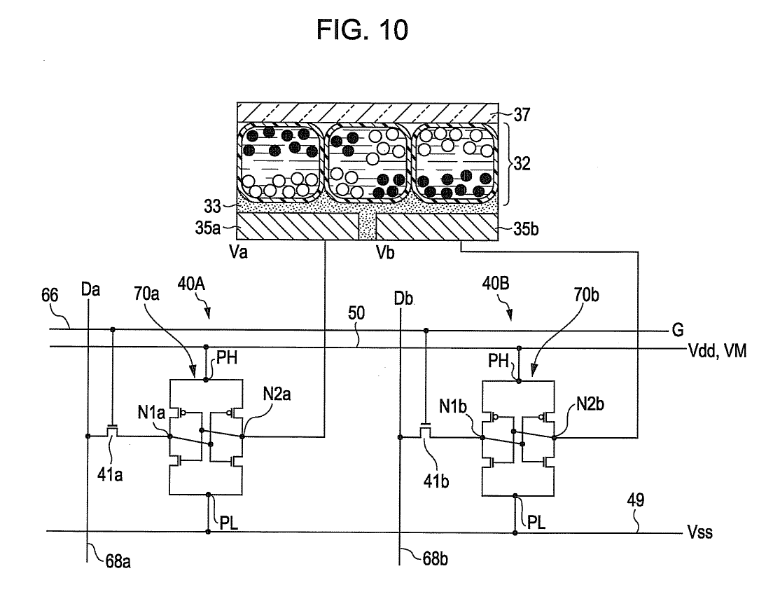

FIG. 9 is a timing chart that schematically illustrates an example of the timing operation of a method for driving the electrophoretic display device 100 according to the first embodiment of the invention. The timing chart of FIG. 9 corresponds to the flowchart of FIG. 8. FIG. 10 is a diagram that schematically illustrates two arbitrary selected pixels 40A and 40B, which are referred to as an example in the following description of the present embodiment of the invention. It should be noted that each of subscripts “A”, “B”, “a”, and “b” that follows a reference numeral in FIGS. 9 and 10 as in pixels 40A and 40B is used merely for the purpose of identifying a pixel, its component elements, and a corresponding data line as well as for distinguishing one of these two pixels 40 from the other. There is no other specific reason, intention, or meaning for the use of these subscripts herein.

FIG. 9 shows the electric potential G of the scanning line 66, the electric potential Vdd of the high voltage power supply line 50, the electric potential Vss of the low voltage power supply line 49, the electric potential of the data input terminal N1a of the latch circuit 70a, the electric potential of the data input terminal N1b of the latch circuit 70b, the electric potential Vcom of the common electrode 37, the electric potential Va of the pixel electrode 35a, and the electric potential Vb of the pixel electrode 35b. The pixel 40A illustrated in FIG. 10 is an example of pixels each of which is put into a black display state in the image display step, which will be explained later. The pixel 40B illustrated in FIG. 10 is an example of pixels each of which is put into a white display state in the image display step.

A method for driving the electrophoretic display device 100 according to the present embodiment of the invention is explained in detail below. In the image signal input step ST1, the pixel-writing high-level electric potential VL (e.g., 5V) is supplied to the high voltage power supply line 50 (Vdd). Specifically, the switching signal XVLSEL (low level), which puts the second switching circuit SC2 only into an ON state, is inputted to the voltage selection circuit 64a shown in FIG. 7A. Then, the pixel-writing high-level electric potential VL is outputted from the output terminal Nout and then supplied to the high voltage power supply line 50 as an input. On the other hand, the ground potential GND (0V, low level) is inputted to the low voltage power supply line 49 (Vss). The common electrode 37 is in a high impedance state.

The image data D that has been inputted into the data buffer 164 of the controller 63 is transferred to the controlling circuit 161. The controlling circuit 161 supplies the image data D to the memory controlling circuit 166. The memory controlling circuit 166 expands the image data D, which has been supplied from the controlling circuit 161, and then writes the expanded data into the frame memory 165. Through these procedures, preparation for displaying an image on the image display unit 5 on the basis of the image data D is completed.

Then, as illustrated in FIG. 9, an image signal is inputted into the latch circuit 70 of each pixel 40. That is, a pulse having a high level (H), which is a selection signal, is inputted to the scanning line 66. The driving thin film transistors (TFT) 41 that are electrically connected to the selected scanning line 66 are put into an ON state. As the driving TFT 41 turns ON, the latch circuit 70 becomes electrically connected to the data line 68. An image signal supplied from the frame memory 165 is inputted into the latch circuit 70.

An image signal having the low level (i.e., ground potential GND; 0V) is inputted into the latch circuit 70a of the pixel 40A through the driving TFT 41a thereof from the corresponding data line 68a. The low-level image signal corresponds to image data “0”, the input of which causes black display. Upon the reception of the image signal having the L level, the electric potential of the data input terminal N1a of the latch circuit 70a is set into the ground potential GND whereas the electric potential of the data output terminal N2a thereof is set into the pixel-writing high-level electric potential VL. On the other hand, an image signal having the high level (i.e., pixel-writing high-level electric potential VL; 5V) is inputted into the latch circuit 70b of the pixel 40B through the driving TFT 41b thereof from the corresponding data line 68b. The high-level image signal corresponds to image data “1”, the input of which causes white display. Upon the reception of the image signal having the H level, the electric potential of the data input terminal N1b of the latch circuit 70b is set into the pixel-writing high-level electric potential VL whereas the electric potential of the data output terminal N2b thereof is set into the ground potential GND, that is, the L level.

The electric potential of the pixel electrode 35a, which is electrically connected to the latch circuit 70a, takes the value of the pixel-writing high-level electric potential VL in the image signal input step ST1. The electric potential of the pixel electrode 35b, which is electrically connected to the latch circuit 70b, takes the value of the ground potential GND in the image signal input step ST1. However, the migration state of the electrophoretic element 32, and thus the display state thereof, does not change because the common electrode 37 is set in a high impedance state in the image signal input step ST1.

After the input of an image signal into each of the pixels 40A and 40B, the process proceeds to the image display step ST2. In the image display step ST2, the electric potential Vdd of the high voltage power supply line 50 is raised from the pixel-writing high-level electric potential VL (e.g., 5V) to the driving high-level electric potential VH (e.g., 15V). The driving high-level electric potential VH is a voltage level for driving the electrophoretic element 32. Specifically, the second switching circuit SC2 of the voltage selection circuit 64a is switched into an OFF state whereas the first switching circuit SC1 thereof is switched into an ON state so that the driving high-level electric potential VH should be outputted from the output terminal Nout to the high voltage power supply line 50. The electric potential Vss of the low voltage power supply line 49 is set into the ground potential GND (0V). A rectangular pulse that alternates between the driving high-level electric potential VH and the ground potential GND at a certain cycle, that is, in a periodic manner, is inputted in the common electrode 37.

As a result thereof, the electric potential of the data output terminal N2a of the latch circuit 70a goes up to the driving high-level electric potential VH in the pixel 40A. Accordingly, the electric potential Va of the pixel electrode 35a takes the value of the driving high-level electric potential VH in the pixel 40A. Since the rectangular pulse is inputted in the common electrode 37, an electric potential difference arises between the pixel electrode 35a and the common electrode 37 during a time period in which the common electrode 37 takes the value of the ground potential GND. The electrophoretic element 32 is driven due to the electric potential difference that arises therebetween. That is, as illustrated in FIG. 5B, the black particles 26, each of which is positively charged, are drawn to the common electrode 37, whereas the white particles 26, each of which is negatively charged, are drawn to the pixel electrode 35a. As a consequence of the migration of the electrophoretic particles 26 and 27 explained above, the pixel 40A is put into a black display state.

On the other hand, since the electric potential of the data output terminal N2b of the latch circuit 70b is set at the ground potential GND in the pixel 40B, the electric potential Vb of the pixel electrode 35b takes the value of the ground potential GND in the pixel 40B. Since the rectangular pulse is inputted in the common electrode 37, an electric potential difference arises between the pixel electrode 35b and the common electrode 37 during a time period in which the common electrode 37 takes the value of the driving high-level electric potential VH. The electrophoretic element 32 is driven due to the electric potential difference that arises therebetween. That is, as illustrated in FIG. 5A, the white particles 26, each of which is negatively charged, are drawn to the common electrode 37, whereas the black particles 26, each of which is positively charged, are drawn to the pixel electrode 35b. As a consequence of the migration of the electrophoretic particles 26 and 27 explained above, the pixel 40B is put into a white display state.

Through a series of operations in the image signal input step ST1 and the image display step ST2 explained above, it is possible to display an image based on the image data D on the image display unit 5.

After the completion of the image display operation, the process proceeds to the first image holding step ST3 as shown in FIG. 8. In the first image holding step ST3, the common electrode 37 is in a high impedance state. Specifically, the first switching circuit SC1 of the voltage selection circuit 64a is switched into an OFF state whereas the third switching circuit SC3 thereof is switched into an ON state so that the voltage level of the high voltage power supply terminal PH of the latch circuit 70 is lowered from the driving high-level electric potential VH to the cell electric potential VB. That is, the latch circuit 70 keeps a power ON state that is driven by the cell electric potential VB (e.g., 2V) and holds the image signal that was inputted in the image signal input step ST1.

In the first image holding step ST3, since the latch circuit 70 keeps the electric potential, the electric potential Va of the pixel electrode 35a takes the value of the cell electric potential VB whereas the electric potential Vb of the pixel electrode 35b takes the value of the ground potential GND; however, the electrophoretic element 32 is never driven in the first image holding step ST3 because the common electrode 37 is in a high impedance state. For this reason, the display state of the display area 5 does not change in the first image holding step ST3. The same holds true for the second image holding step ST5, which will be explained later.

After a certain length of time has elapsed since the transition into the first image holding step ST3, the process proceeds to the refresh step ST4. The third switching circuit SC3 of the voltage selection circuit 64a is switched into an OFF state whereas the first switching circuit SC1 thereof is switched into an ON state in the refresh step ST4. Because of such switch setting, the electric potential Vdd of the high voltage power supply line 50 is raised again to the driving high-level electric potential VH as shown in FIG. 9. A rectangular pulse that alternates between the driving high-level electric potential VH and the ground potential GND at a certain cycle, that is, in a periodic manner, is inputted in the common electrode 37.

Accordingly, an electric potential difference arises between the pixel electrode 35 (35a) and the common electrode 37 during a time period in which the common electrode 37 takes the value of the ground potential GND. The electrophoretic element 32 is driven due to the electric potential difference that arises therebetween. Therefore, the pixel 40 (40A) is put into a black display state. As a result of the black display of the pixel 40 (40A), it is possible to return the level of contrast, which has been decreasing as time elapses, to a level measured at a point in time immediately after the image display step ST2 thereat. On the other hand, an electric potential difference arises between the pixel electrode 35 (35b) and the common electrode 37 during a time period in which the common electrode 37 takes the value of the driving high-level electric potential VH. The electrophoretic element 32 is driven due to the electric potential difference that arises therebetween. Therefore, the pixel 40 (40B) is put into a white display state. As a result of the white display of the pixel 40 (40B), it is possible to return the level of contrast, which has been decreasing as time elapses, to a level measured at a point in time immediately after the image display step ST2 thereat.

In the illustrated example of FIG. 9, a pulse of two cycles is inputted to the common electrode 37 in the refresh step ST4. However, the scope of this aspect of the invention is not limited to such an exemplary pulse pattern. For example, it suffices if the pulse that is inputted to the common electrode 37 in the refresh step ST4 has at least one time period of the driving high-level electric potential VH and at least one time period of the ground potential GND. Or, the length of the refresh time period may be increased so that a pulse of three or more cycles is inputted to the common electrode 37 in the refresh step ST4.

After the contrast of a display image has been restored (i.e., recovered) in the refresh step ST4, the process proceeds to the second image holding step ST5. In the second image holding step ST5, the display image is held for a long time period by putting the common electrode 37 into a high impedance state while holding the image signal with the minimum power consumption by lowering the power voltage of the latch circuit 70 to the cell electric potential VB (high level) again. Thereafter, the refresh step ST4 and the image holding step ST5 (ST3) are repeated one after the other. By this means, it is possible to keep the contrast of a display image.

If a method for driving the electrophoretic display device 100 according to the present embodiment of the invention is used, which is explained in detail above, it is possible to keep a display image without a contrast decrease for a long time because the first image holding step ST3 and the refresh step ST4 are provided after the image display step ST2. In addition, since the latch circuit 70 continues to be in operation without being powered OFF in the first image holding step ST3, it is possible to execute refresh operation without any need to input an image signal again into the latch circuit 70. Therefore, it is possible to avoid power consumption due to image signal transfer. Moreover, since the electric potential Vdd of the high voltage power supply terminal PH, in other words, the electric potential Vdd of the high voltage power supply line 50, is lowered to the cell electric potential VB in the first image holding step ST3 so as to reduce the driving voltage of the latch circuit 70 to the minimum voltage of the electrophoretic display device 100, it is possible to achieve small power consumption in the image holding steps ST3 and ST5. Furthermore, since the electrophoretic display device 100 according to the present embodiment of the invention is provided with the voltage selection circuit 64a shown in FIG. 7, it is possible to freely supply the cell electric potential VB to the high voltage power supply line 50.

Although the length of the first image holding step ST3 is not specifically limited herein, if the first image holding step ST3 is set as a long time period, the amount of a contrast loss/drop is large, which inevitably makes it necessary to set the duration of driving the electrophoretic element 32 in the refresh step ST4 as a long time. In addition to the disadvantage of a longer electrophoretic-element driving time described above, as another disadvantage thereof, the amount of contrast change due to refresh operation increases, which is more likely to be visually perceived. For these reasons, it is preferable to set the length of the first image holding step ST3 at such a value that refresh operation should be performed at a certain point in time at which no excessive contrast decrease has occurred yet.

In a method for driving the electrophoretic display device 100 according to the present embodiment of the invention, a rectangular pulse of a plurality of cycles that periodically alternates between the driving high-level electric potential VH and the ground potential GND is inputted in the common electrode 37 in the image display step ST2. Such a driving method is called as “pulsed common level switchover drive scheme” in this specification. The pulsed common level switchover drive scheme is herein defined as a driving method in which a pulse of at least one cycle that alternates between the driving high-level electric potential VH (i.e., high level) and the ground potential GND (i.e., low level) is inputted in the common electrode 37 in the image display step ST2.

If the pulsed common level switchover drive scheme is adopted as in the foregoing exemplary embodiment of the invention, it is possible to enhance contrast because the pulsed common level switchover drive scheme achieves the migration of each of black particles and white particles to a destination electrode with increased reliability. Moreover, it is possible to perform binary control on the level of an electric potential that is applied to the pixel electrode 35 and the level of an electric potential that is applied to the common electrode 37 with the use of two values, that is, the driving high-level electric potential VH and the ground potential GND. Such binary control is advantageous in that it is possible to achieve a low-voltage simple circuit configuration. Furthermore, in a case where a TFT is used as the switching element of the pixel electrode 35, there is another advantage in that low-voltage drive operation enhances the reliability of the TFT. It is preferable to determine each of the frequency of the pulsed common level switchover drive operation and the number of cycles thereof at an appropriate value on the basis of the specification of the electrophoretic element 32 and the characteristics thereof.

Notwithstanding the above, however, an alternative driving method may be used in the image display step ST2 according to the present embodiment of the invention in place of the pulsed common level switchover drive scheme. In such a modified driving method, the image display step ST2, that is, the image display time period, is divided into a black image display time period and a white image display time period. In the black image display time period, the level of the common electrode 37 is fixed at the ground potential GND. In the white image display time period, the level of the common electrode 37 is fixed at the driving high-level electric potential VH. By this means, the pixel 40A is put into in a black display state in the black image display time period, whereas the pixel 40B is put into in a white display state in the white image display time period. Thus, it is possible to display an image on the image display unit 5 as done in the exemplary embodiment of the invention described above.

### Second Embodiment

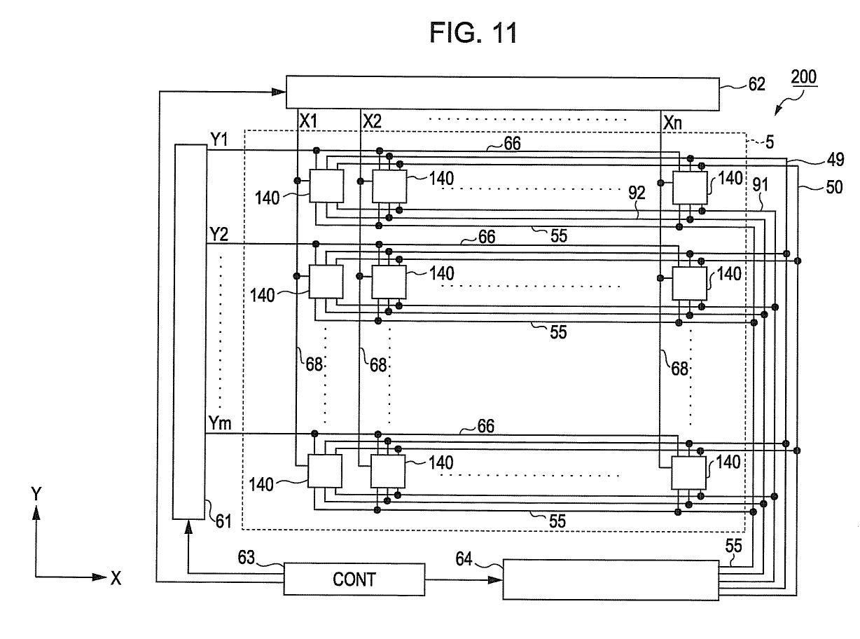

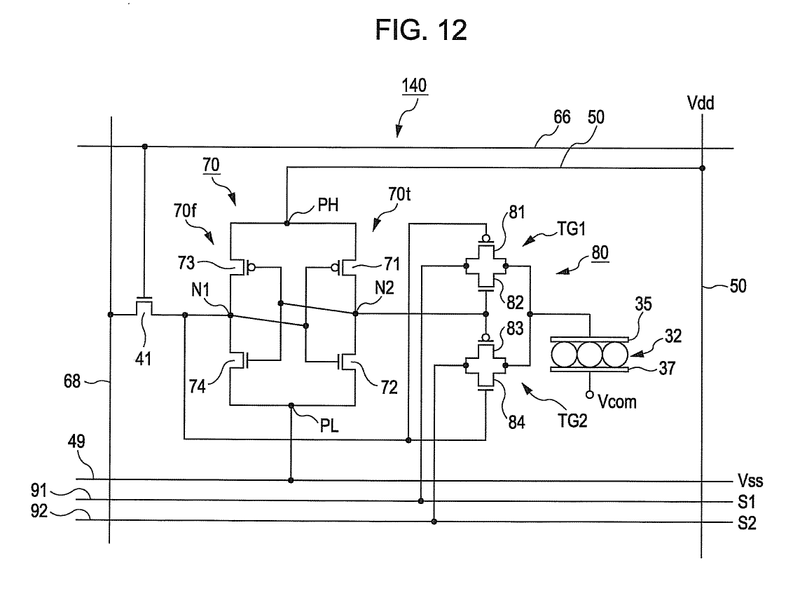

Next, with reference to the accompanying drawings, an electrophoretic display device according to a second embodiment of the invention is explained below. FIG. 11 is a schematic diagram that illustrates an example of the configuration of an electrophoretic display device 200 according to a second embodiment of the invention. FIG. 12 is a circuit diagram that schematically illustrates an example of the configuration of one of pixel circuits of the electrophoretic display device 200 according to the second embodiment of the invention. In the following description of the electrophoretic display device 200 according to the second embodiment of the invention, differences in the configuration and the operation thereof from those of the electrophoretic display device 100 according to the first embodiment of the invention are mainly explained while making reference to the accompanying drawings. Therefore, in the following description of the electrophoretic display device 200 according to the second embodiment of the invention as well as in the illustration of FIGS. 11 and 12, the same reference numerals are consistently used for the same components as those of the electrophoretic display device 100 according to the foregoing first embodiment of the invention so as to omit, if appropriate, any redundant explanation or simplify explanation thereof.

As illustrated in FIG. 11, the electrophoretic display device 200 is provided with the image display unit 5 in which a plurality of pixels 140 is arrayed in a matrix layout. A first control line 91 and a second control line 92, each of which extends from the common power supply modulation circuit 64, are connected to each pixel 140. The aforementioned other lines that are electrically connected to the pixel 140, that is, the scanning line 66, the data line 68, the common electrode line 55, the high voltage power supply line 50, and the low voltage power supply line 49, have the same configuration as that of the electrophoretic display device 100 according to the first embodiment of the invention.

As illustrated in FIG. 12, the pixel 140 of the electrophoretic display device 200 has a switching circuit 80 in addition to the pixel components of the pixel 40 shown in FIG. 2. The switching circuit 80 is provided between the latch circuit 70 and the pixel electrode 35. The switching circuit 80 includes a first transmission gate TG1 and a second transmission gate TG2.

The first transmission gate TG1 is made up of a P-MOS transistor 81 and an N-MOS transistor 82. The source terminal of each of the P-MOS transistor 81 and the N-MOS transistor 82 is electrically connected to the first control line 91. The drain terminal of each of the P-MOS transistor 81 and the N-MOS transistor 82 is electrically connected to the pixel electrode 35. The gate terminal of the P-MOS transistor 81 is electrically connected to the data input terminal N1 of the latch circuit 70. In other words, the gate terminal of the P-MOS transistor 81 is electrically connected to the drain terminal of the driving TFT 41. The gate terminal of the N-MOS transistor 82 is electrically connected to the data output terminal N2 of the latch circuit 70.

The second transmission gate TG2 is made up of a P-MOS transistor 83 and an N-MOS transistor 84. The source terminal of each of the P-MOS transistor 83 and the N-MOS transistor 84 is electrically connected to the second control line 92. The drain terminal of each of the P-MOS transistor 83 and the N-MOS transistor 84 is electrically connected to the pixel electrode 35. The gate terminal of the P-MOS transistor 83 is electrically connected to the data output terminal N2 of the latch circuit 70. The gate terminal of the N-MOS transistor 84 is electrically connected to the data input terminal N1 of the latch circuit 70.

The electrophoretic display device 200 according to the present embodiment of the invention, which has the configuration described above, displays an image on the display area 5 thereof as follows. An image signal is inputted to the data input terminal N1 of the latch circuit 70 through the driving TFT 41. Upon the reception of the image signal at the data input terminal N1, the latch circuit 70 memorizes the image signal as an electric potential. Accordingly, the switching circuit 80, which operates on the basis of an electric potential that is outputted from the data input terminal N1 of the latch circuit 70 and the data output terminal N2 thereof, establishes an electric connection between the first control line 91 and the pixel electrode 35 or between the second control line 92 and the pixel electrode 35. Consequently, the electric potential corresponding to the inputted image signal is inputted into the pixel electrode 35 from the first control line 91 or the second control line 92. As a result thereof, the pixel 140 is put into either a white display state shown in FIG. 5A or a black display state shown in FIG. 5B on the basis of a difference between the electric potential of the pixel electrode 35 and the electric potential of the common electrode 37.

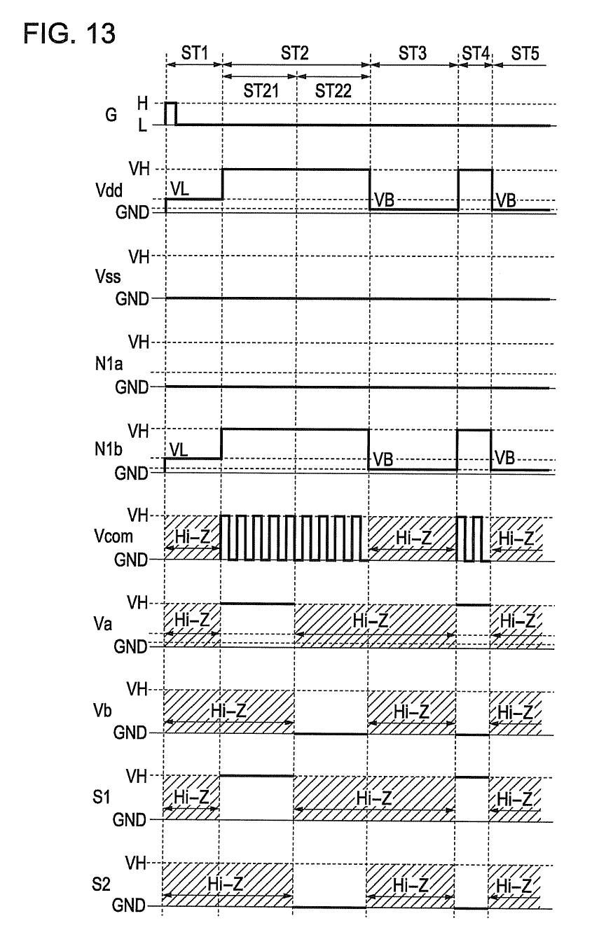

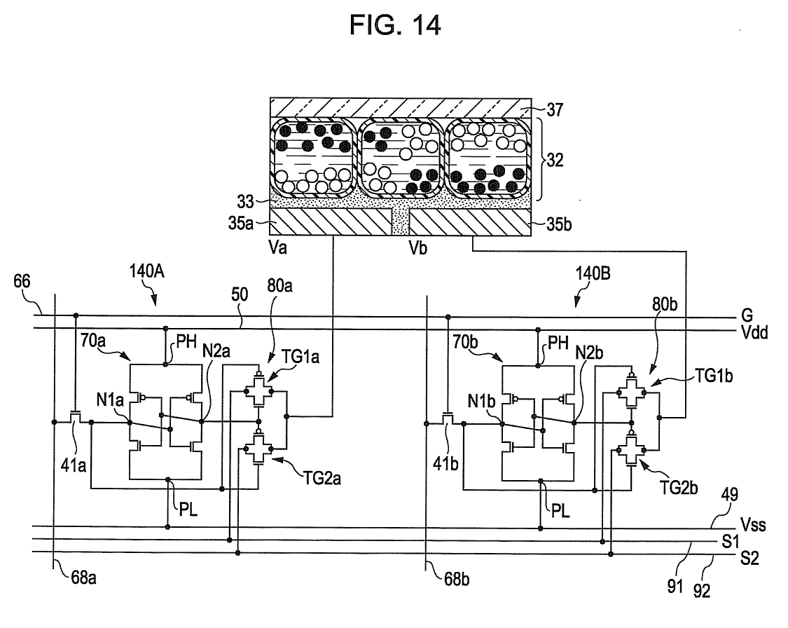

FIG. 13 is a timing chart that schematically illustrates an example of the timing operation of a method for driving the electrophoretic display device 200 according to the second embodiment of the invention. The timing chart of FIG. 13 corresponds to FIG. 9, which shows an example of the timing operation according to the foregoing first embodiment of the invention. FIG. 14 is a diagram that schematically illustrates a black-display pixel 140A and a white-display pixel 140B that are driven by a method for driving the electrophoretic display device 200 according to the present embodiment of the invention. FIG. 14 corresponds to FIG. 10, which shows the pixels 40A and 40B according to the foregoing first embodiment of the invention. FIG. 13 shows the timing patterns of an electric potential S1 of the first control line 91 and an electric potential S2 of the second control line 92 in addition to the timing patterns of the electric potentials shown in the timing chart of FIG. 9 according to the first embodiment of the invention.

Substantially the same driving method as the driving method according to the first embodiment of the invention described above, which is shown in the flowchart of FIG. 8, can be adopted for the driving operation of the electrophoretic display device 200 according to the present embodiment of the invention. That is, as a method for driving the electrophoretic display device 200 according to the present embodiment of the invention, a driving method that includes a sequence of the image signal input step ST1, the image display step ST2, the first image holding step ST3, the refresh step ST4, and the second image holding step ST5 can be used. An image signal is inputted into the latch circuit 70 of the pixel 140 in the image signal input step ST1. An image is displayed on the image display unit 5 on the basis of the written image signal in the image display step ST2. The display image is held in the first image holding step ST3. The contrast of the display image is restored in the refresh step ST4. The display image is held in the second image holding step ST5.

As a point of difference from the driving method according to the foregoing first embodiment of the invention, as illustrated in FIG. 13, the image display step ST2 of the driving method according to the present embodiment of the invention is split into a black image display sub-step 21 and a white image display sub-step 22. Black display is performed throughout the black image display time period 21 whereas white display is performed throughout the white image display time period 22 so as to display an image on the display area 5.

The driving high-level electric potential VH is supplied to the first control line 91 as an input whereas the second control line 92 is set in a high impedance state in the black image display sub-step 21. As a result thereof, the electric potential Va of the pixel electrode 35a of the pixel 140A takes the value of the driving high-level electric potential VH whereas the pixel electrode 35b of the pixel 140B is set in a high impedance state. Therefore, the electrophoretic element 32 that is provided in the pixel 140A only is driven so that the pixel 140A should be put into a black display state.

On the other hand, in the white image display sub-step 22, the first control line 91 is set in a high impedance state whereas the ground potential GND is supplied to the second control line 92 as an input. As a result thereof, the electric potential Vb of the pixel electrode 35b of the pixel 140B takes the value of the ground potential GND whereas the pixel electrode 35a of the pixel 140A is set in a high impedance state. Therefore, the electrophoretic element 32 that is provided in the pixel 140B only is driven so that the pixel 140B should be put into a white display state. In this way, an image based on image data is displayed in the display area 5.

In a method for driving the electrophoretic display device 200 according to the present embodiment of the invention, the second control line 92 is in a high impedance state in the black image display sub-step 21 of the image display step ST2 whereas the first control line 91 is in a high impedance state in the white image display sub-step 22 thereof. This means that, at any point in time in the image display step ST2, either one of these control lines 91 and 92 is in a high impedance state. For this reason, it is possible to prevent any electric current from leaking through the adhesive layer 33 and/or the microcapsules 20 due to a difference between the electric potential of the pixel electrode 35a and the electric potential of the pixel electrode 35b, which is provided adjacent to the pixel electrode 35a. Thus, this aspect of the invention makes it possible to achieve an electrophoretic display device having excellent power-saving characteristics.

In addition, in a method for driving the electrophoretic display device 200 according to the present embodiment of the invention, both of the first control line 91 and the second control line 92 are set in a high impedance state in each of the first image holding step ST3 and the second image holding step ST5. Accordingly, the pixel electrode 35, which is electrically connected to either one of the first control line 91 and the second control line 92 depending on the output of the latch circuit 70, is also set in a high impedance state. Thus, the electrophoretic display device 200 according to the present embodiment of the invention and the driving method thereof are substantially free from any leakage current in the first and second image holding steps ST3 and ST5 in addition to the image display step ST2.

In the timing operation of the electrophoretic display device 200 according to the present embodiment of the invention, an electric potential input is supplied to each of the first control line 91 and the second control line 92 throughout the refresh step ST4 because a voltage that is applied to the pixel electrode 35 is supplied through the first control line 91 or the second control line 92. Since the duration of the refresh step S4 is short, it is reasonably considered that the amount of a leakage current that is generated even when an electric potential input is supplied to both of the first control line 91 and the second control line 92 as shown in FIG. 13 is small. Notwithstanding the above, however, in order to prevent any leakage current from occurring with greater reliability, it is preferable to split the refresh step ST4 into a black image display sub-step and a white image display sub-step as done in the image display step ST2. In such a preferred timing operation, an electric potential input is supplied to either one of the first control line 91 and the second control line 92 in each of the black image display sub-step and the white image display sub-step whereas the other thereof is put in a high impedance state with a switchover therebetween.

Moreover, since the switching circuit 80 is provided between the latch circuit 70 and the pixel electrode 35 in the circuit configuration of the electrophoretic display device 200 according to the present embodiment of the invention, it is possible to control the display of an image on the image display unit 5 through the manipulation of the electric potential of the first control line 91 and the electric potential of the second control line 92, each of which is electrically connected to the switching circuit 80, independently of the electric potential that is held in the latch circuit 70.

For example, if the driving high-level electric potential VH is supplied as an input to both of the first control line 91 and the second control line 92, the driving high-level electric potential VH is applied to the pixel electrodes 35 of all pixels 140. Through the application of the ground potential GND (i.e., low level) to the common electrode 37 with the driving high-level electric potential VH being supplied as an input to both of the first control line 91 and the second control line 92, that is, each pixel electrode 35, it is possible to display the entire area of the image display unit 5 in black. If the ground potential GND (i.e., low level) is supplied as an input to both of the first control line 91 and the second control line 92, the ground potential GND is applied to the pixel electrodes 35 of all pixels 140. Through the application of the driving high-level electric potential VH to the common electrode 37 with the ground potential GND being supplied as an input to both of the first control line 91 and the second control line 92, that is, each pixel electrode 35, it is possible to display the entire area of the image display unit 5 in white. For this reason, a method for driving the electrophoretic display device 200 according to the present embodiment of the invention makes it possible to erase an image displayed in the display area 5 without a need to transfer an image signal to the latch circuit 70.

### Electronic Apparatus

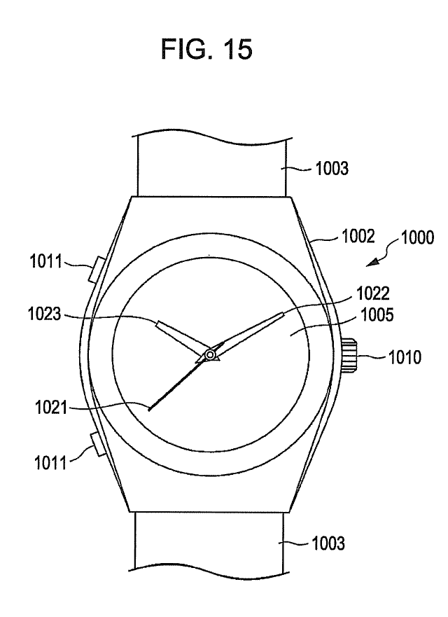

In the following description, a few non-limiting application examples of an aspect of the invention in which the electrophoretic display device 100/200 according to the foregoing exemplary embodiment of the invention is applied to an electronic apparatus are explained. FIG. 15 is a front view that schematically illustrates an example of the configuration of a watch 1000 to which the electrophoretic display device 100/200 according to the foregoing exemplary embodiment of the invention is applied. The watch 1000 is provided with a watchcase 1002 and a watchband 1003. The watchband 1003 is attached to the watchcase 1002. An image display unit, that is, a display area 1005 is formed on the face of the watchcase 1002. The image display unit 1005 is made of the electrophoretic display device 100 according to the first embodiment of the invention described above or the electrophoretic display device 200 according to the second embodiment of the invention described above. In addition to the display area 1005, the watch 1000 has a second hand 1021, a minute hand 1022, and an hour hand 1023. A crown 1010 and a manipulation button 1011, each of which is used for the adjustment, operation, and manipulation of the watch 1000, are provided on the side of the watchcase 1002. The crown 1010 is mechanically connected to a winding stem, which is provided inside the watchcase 1002. Note that the winding stem is not illustrated in the drawing. A user can push the crown 1010 interlocked with the winding stem inward and pull it outward freely so that the position of the crown 1010 and the winding stem interlocked therewith can be set at one of a plurality of crown positions. For example, there are two crown positions. In addition, the user can turn the crown 1010 interlocked with the winding stem freely. It is possible to display a character string such as date and hour or a second hand, a minute hand, and an hour hand as well as a background image in the display area 1005.

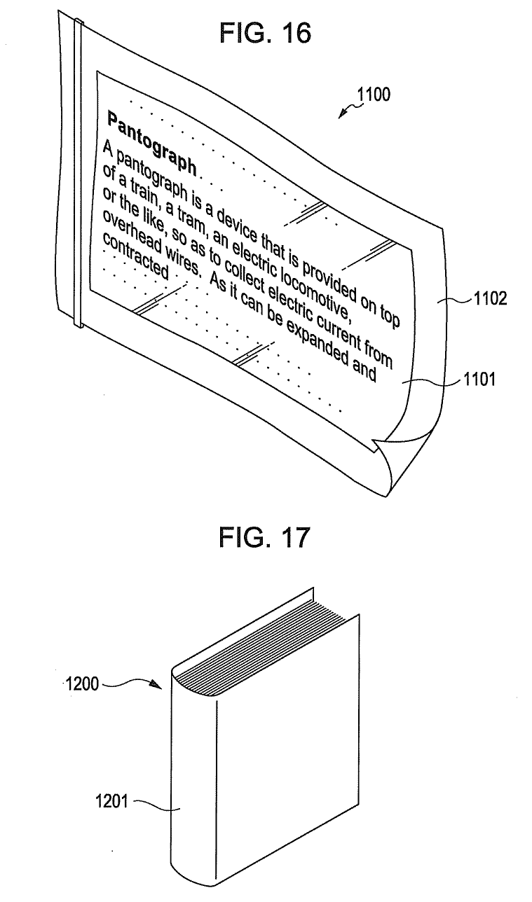

FIG. 16 is a perspective view that schematically illustrates an example of the configuration of a sheet of electronic paper 1100. The electronic paper 1100 has the electrophoretic display device 100 according to the first embodiment of the invention described above or the electrophoretic display device 200 according to the second embodiment of the invention described above as its display area 1101. The electronic paper 1100 has a thin body part 1102. The thin body part 1102 of the electronic paper 1100 is made of a sheet material that has almost the same texture and flexibility as those of conventional paper (i.e., normal non-electronic paper). An electrophoretic display device according to an exemplary embodiment of the invention is provided on the surface of the thin body part 1102 of the electronic paper 1100.

FIG. 17 is a perspective view that schematically illustrates an example of the configuration of an electronic notebook 1200, which is an example of an electronic apparatus according to the present embodiment of the invention. The electronic notebook 1200 has a plurality of sheets of the electronic paper 1100, which is explained above while referring to FIG. 13. The electronic notebook 1200 is further provided with a book jacket 1201, which covers the sheets of electronic paper 1100. The book jacket 1201 is provided with a display data input unit that supplies (i.e., inputs) display data that has been sent from, for example, an external device. The display data input unit is not shown in the drawing. Having such a configuration, the electronic notebook 1200 illustrated in FIG. 17 is capable of changing and/or updating (i.e., overwriting) display content in accordance with the supplied display data without any necessity to unbind the electronic paper 1100.

Each of the watch 1000, the electronic paper 1100, and the electronic notebook 1200 described above is provided with the electrophoretic display device 100 according to the foregoing first embodiment of the invention or the electrophoretic display device 200 according to the foregoing second embodiment of the invention as its image display unit. Therefore, each of the watch 1000, the electronic paper 1100, and the electronic notebook 1200 described above has excellent power-saving characteristics. Needless to say, it should be understood that each of the electronic apparatuses described above are provided merely for the purpose of illustrating some application examples of an aspect of the invention, and therefore, never intended to limit the scope of the invention. Various arbitrary and/or discretionary modifications, alterations, changes, adaptations, improvements, or the like can be made on the explanation given herein without departing from the spirit and scope of the invention. In addition to the watch 1000, the electronic paper 1100, and the electronic notebook 1200 described above, it is possible to apply an electrophoretic display device according to the foregoing exemplary embodiment of the invention to a display unit of a variety of electronic apparatuses including but not limited to a mobile phone and a handheld audio device.

The entire disclosure of Japanese Patent Application No. 2008-075438, filed Mar. 24, 2008 is expressly incorporated by reference herein.

What is claimed is:

1. A method for driving an electrophoretic display device that is provided with a display unit having a pixel, the pixel including:
a pixel electrode;
a common electrode;
an electrophoretic element containing a plurality of electrophoretic particles, the electrophoretic element being located between the pixel electrode and the common electrode;
a pixel-switching element; and
a latch circuit connected between the pixel electrode and the pixel-switching element,
the driving method comprising:
during an image display time period, causing the display unit to display an image;
during an image holding time period, holding the displayed image; and
during a refresh time period, causing the display unit to display the image again;
wherein, during the image holding time period, the power voltage of the latch circuit is set at the minimum voltage of a power system provided in the electrophoretic display device.

2. The method for driving an electrophoretic display device according to claim 1, wherein the above-mentioned minimum voltage is the voltage of a battery provided in the power system.

3. The method for driving an electrophoretic display device according to claim 1, wherein, during the refresh step, the power voltage of the latch circuit is raised from the above-mentioned minimum voltage to a voltage that is high enough to drive the electrophoretic element.

4. An electrophoretic display device comprising:
a display unit including a pixel, the pixel having:
a pixel electrode;
a common electrode;
an electrophoretic element containing a plurality of electrophoretic particles, the electrophoretic element being located between the pixel electrode and the common electrode;
a pixel-switching element; and
a latch circuit connected between the pixel electrode and the pixel-switching element,
wherein, the electrophoretic display device is operated in a sequence of time periods including
an image display time period throughout which or in which the display unit is caused to display an image,
an image holding time period throughout which or in which the displayed image is held, and
a refresh time period throughout which or in which the display unit is caused to display the image again,
wherein, throughout the image holding time period or in the image holding time period, the power voltage of the latch circuit is set at the minimum voltage of a power system provided in the electrophoretic display device.

5. The electrophoretic display device according to claim 4, wherein the above-mentioned minimum voltage is the voltage of a battery provided in the power system.

6. The electrophoretic display device according to claim 4, further comprising a voltage selection circuit that supplies a plurality of power voltages to the latch circuit while performing a switchover among the plurality of power voltages, the voltage selection circuit being capable of outputting selected one through an output terminal among a first high level electric potential, which is the maximum electric potential, a second high level electric potential, and a third high level electric potential, which is the minimum electric potential,
wherein a first switching circuit, which supplies the first high level electric potential to the output terminal, has a high withstand voltage transistor and a first level shifter, the first level shifter being electrically connected to the gate terminal of the high withstand voltage transistor;
a second switching circuit, which supplies the second high level electric potential to the output terminal, has a first low withstand voltage transistor, a second level shifter, and a first diode, the second level shifter being electrically connected to the gate terminal of the first low withstand voltage transistor, the first diode being interposed between the first low withstand voltage transistor and the output terminal; and
a third switching circuit, which supplies the third high level electric potential to the output terminal, has a second low withstand voltage transistor and a second diode, which is interposed between the second low withstand voltage transistor and the output terminal.

7. An electronic apparatus that is provided with the electrophoretic display device according to claim 4.
